(19) United States
(12) Patent Application Publication
(10) Pub. No.: US 2026/0253312 A1
(43) Pub. Date: Aug. 27, 2026

(54) PROCESSING DEVICE, PROCESSING METHOD, AND RECORDING MEDIUM

(71) Applicant: NEC Corporation, Tokyo (JP)

(72) Inventors: Masahiro YAMAGUCHI, Tokyo (JP); Kyota HIGA, Tokyo (JP)

(73) Assignee: NEC Corporation, Tokyo (JP)

(21) Appl. No.: 19/160,173

(22) PCT Filed: Mar. 8, 2023
(86) PCT No.: PCT/JP2023/008887

§ 371 Date: Aug. 27, 2025

(51) Int. Cl. G06T 15/08; G06T 7/12

(52) U.S. Cl. CPC G06T 15/08; G06T 7/12; G06T 2207/20081

(57) ABSTRACT

To provide a new technique for reproducing a three-dimensional structure, a processing device includes, a specification unit that identifies a non-estimation target voxel group, an estimation/completion unit that calculates the voxel values of estimable voxels and complements the voxel values of non-estimable voxels among voxels included in an estimation target voxel group, and an assignment unit that assigns a confidence level to each voxel included in the estimation target voxel group.

### TECHNICAL FIELD

The present disclosure relates to a processing device, a processing method, and a processing program.

### BACKGROUND ART

When a three-dimensional region is reproduced as a three-dimensional structure using a color image and/or a depth image obtained by imaging the three-dimensional region, a portion that is not reproduced as the three-dimensional structure may occur due to the camera position, the accuracy of the device, the texturless region, and the like. Under such circumstances, PTL 1, NPL 1, and NPL 2 disclose technologies for complementing a portion that is not reproduced as a three-dimensional structure.

### CITATION LIST

### Patent Literature

PTL 1: JP 2019-28861 A

### Non Patent Literature

NPL 1: Angela Dai et. al., ScanComplete: Large-Scale Scene Completion and Semantic Segmentation for 3D Scans, 2018 IEEE/CVF Conference on Computer Vision and Pattern Recognition (CVPR), Salt Lake City, UT, USA, 2018 pp. 4578-4587.

NPL 2: Wenbo Hu et. al., Cycle4Completion: Unpaired Point CloudCompletion using Cycle Transformation with Missing Region Coding, 2021 IEEE/CVF Conference on Computer Vision and Pattern Recognition (CVPR), Nashville, TN, USA, 2021 pp. 14368-14377.

### SUMMARY OF INVENTION

### Technical Problem

In the technology described in PTL 1, a portion that is not reproduced as a three-dimensional structure is interpolated with reference to the labels of adjacent distance measurement points. Therefore, it is necessary to assign a label corresponding to the type of subject to each distance measurement point.

The complementation of the three-dimensional structures described in NPL 2 and NPL 3 is achieved through training on information regarding a complete three-dimensional structure, such as synthetic data. The indoor three-dimensional structure can be accurately reproduced by using appropriate synthetic data (for example, an SUNCG data set). However, since a wide variety of objects are present outdoors and the terrain included as a background also exhibits a wide variety, it is difficult to create synthetic data used for training for an outdoor three-dimensional structure.

An aspect of the present invention has been made in view of the above problems, and an object thereof is to provide a new technology for complementing a portion that is not reproduced when a three-dimensional structure is reproduced from an image obtained by imaging a three-dimensional region.

### Solution to Problem

According to an aspect of the present invention, there is provided a processing device including: a specification means for identifying, as a non-estimation target voxel group, a voxel group not included in any field of view of one or a plurality of images obtained by imaging a three-dimensional region in a voxel space representing the three-dimensional region; an estimation/completion means for calculating, with reference to the one or the plurality of images, voxel values of estimable voxels whose voxel values are capable of being estimated from the one or the plurality of images, among voxels included in estimation target voxel group obtained by excluding the non-estimation target voxel group from the voxel space, and complementing voxel values of non-estimable voxels whose voxel values are not capable of being estimated from the one or the plurality of images with reference to the voxel values of the estimable voxels; and an assignment means for assigning, to each voxel included in the estimation target voxel group, a confidence level of a voxel value of the voxel, in which the assignment means assigns a confidence level lower than the confidence level assigned to each of the estimable voxels as the confidence level assigned to each of the non-estimable voxels.

According to another aspect of the present invention, there is provided a processing method including causing at least one processor to: identify, as a non-estimation target voxel group, a voxel group not included in any field of view of one or a plurality of images obtained by imaging a three-dimensional region in a voxel space representing the three-dimensional region; calculate, with reference to the one or the plurality of images, voxel values of estimable voxels whose voxel values are capable of being estimated from the one or the plurality of images, among voxels included in estimation target voxel group obtained by excluding the non-estimation target voxel group from the voxel space, and complement voxel values of non-estimable voxels whose voxel values are not capable of being estimated from the one or the plurality of images with reference to the voxel values of the estimable voxels; and assign, to each voxel included in the estimation target voxel group, a confidence level of a voxel value of the voxel, and assign a confidence level lower than the confidence level assigned to each of the estimable voxels as the confidence level assigned to each of the non-estimable voxels.

According to still another aspect of the present invention, there is provided a program for causing a computer to function as a processing device, the program for causing at least one processor included in the computer to function as: a specification means for identifying, as a non-estimation target voxel group, a voxel group not included in any field of view of one or a plurality of images obtained by imaging a three-dimensional region in a voxel space representing the three-dimensional region; an estimation/completion means for calculating, with reference to the one or the plurality of images, voxel values of estimable voxels whose voxel values are capable of being estimated from the one or the plurality of images, among voxels included in estimation target voxel group obtained by excluding the non-estimation target voxel group from the voxel space, and complementing voxel values of non-estimable voxels whose voxel values are not capable of being estimated from the one or the plurality of images with reference to the voxel values of the estimable voxels; and an assignment means for assigning, to each voxel included in the estimation target voxel group, a confidence level of a voxel value of the voxel, in which the assignment means assigns a confidence level lower than the confidence level assigned to each of the estimable voxels as the confidence level assigned to each of the non-estimable voxels.

### Advantageous Effects of Invention

According to the aspects of the present invention, it is possible to provide a new technology for complementing a portion that is not reproduced when a three-dimensional structure is reproduced from the image obtained by imaging the three-dimensional region.

### BRIEF DESCRIPTION OF DRAWINGS

FIG. 1 is a block diagram illustrating a configuration of a processing device 1 according to a first example embodiment of the present invention.

FIG. 2 is a flowchart illustrating a flow of a processing method S1 according to the first example embodiment of the present invention.

FIG. 3 is a diagram illustrating an example of processing by an assignment unit 13 included in a processing device 1 according to the first example embodiment of the present invention.

FIG. 4 is a diagram illustrating an example of processing by an assignment unit 13 included in a processing device 1 according to the first example embodiment of the present invention.

FIG. 5 is a block diagram illustrating a configuration of a processing device 1A according to a second example embodiment of the present invention.

FIG. 6 is a flowchart illustrating a flow of a processing method S1A according to the second example embodiment of the present invention.

FIG. 7 is a block diagram illustrating a configuration of a processing device 1B according to a third example embodiment of the present invention.

FIG. 8 is a flowchart illustrating a flow of a processing method S1B according to the third example embodiment of the present invention.

FIG. 9 is a block diagram illustrating a configuration of a processing program according to a fourth example embodiment of the present invention.

### EXAMPLE EMBODIMENT

### First Example Embodiment

A first example embodiment of the present invention will be described in detail with reference to the drawings. The present example embodiment is a basic form of the example embodiment described below.

### Outline of Processing Device 1

When a voxel group representing a three-dimensional region is created using a color image and/or a depth image obtained by imaging the three-dimensional region, a portion that becomes a blind spot due to an obstacle and a portion without texture are not reproduced as voxels, and may become voxels without features. Even when a task such as three-dimensional semantic segmentation or an object detection task is executed for a voxel group including voxels without features, there is a possibility that the accuracy decreases. A processing device 1 according to the present example embodiment is, for example, a device for improving the accuracy of a task to be executed by complementing a portion that is not reproduced for a three-dimensional structure reproduced to execute the task.

### Configuration of Processing Device 1

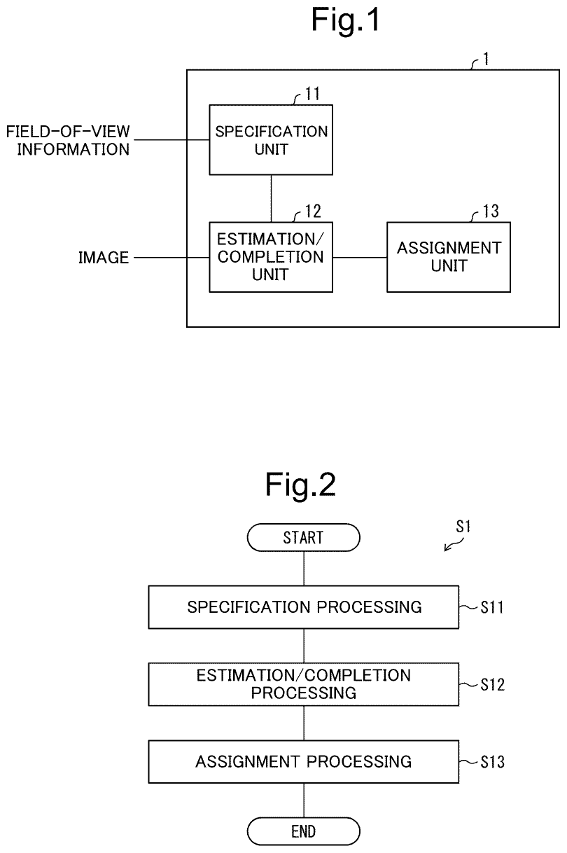

A configuration of the processing device 1 according to the present example embodiment will be described with reference to FIG. 1. FIG. 1 is a block diagram illustrating the configuration of the processing device 1.

As illustrated in FIG. 1, the processing device 1 includes a specification unit 11, an estimation/completion unit 12, and an assignment unit 13. The specification unit 11, the estimation/completion unit 12, and the assignment unit 13 are configured to implement a specification means, an estimation/completion means, and an assignment means, respectively, in the present example embodiment.

The specification unit 11 is configured to identify a non-estimation target voxel group in a voxel space representing a three-dimensional region. As the non-estimation target voxel group, a voxel group not included in the field of view of any one or a plurality of images obtained by imaging the three-dimensional region is identified. The specification unit 11 uses field-of-view information of an image as an input.

The estimation/completion unit 12 is configured to calculate voxel values of estimable voxels among voxels included in the estimation target voxel group and complement the voxel values of non-estimable voxels.

The estimation target voxel group is a voxel group obtained by excluding the non-estimation target voxel group from the voxel space. The estimable voxels refer to voxels whose voxel values can be estimated from one or a plurality of images among the voxels included in the estimation target voxel group. The voxel values of the estimable voxels are calculated with reference to one or a plurality of images. The non-estimable voxels refer to voxels whose voxel values cannot be estimated from one or a plurality of images. The voxel values of the non-estimable voxels are complemented with reference to the voxel values of the estimable voxels. The estimation/completion unit 12 uses one or a plurality of images as inputs.

The assignment unit 13 is configured to assign the confidence level of the voxel value of the voxel to each voxel included in the estimation target voxel group. As the confidence level assigned to each of the non-estimable voxels, a confidence level lower than the confidence level assigned to each estimable voxel is assigned.

### Flow of Processing Method S1

A flow of a processing method SI according to the present example embodiment will be described with reference to FIG. 2. FIG. 2 is a flowchart illustrating the flow of the processing method S1.

As illustrated in FIG. 2, the processing method S1 includes specification processing S11, estimation/completion processing S12, and assignment processing S13.

The specification processing S11 is processing for identifying a non-estimation target voxel group in a voxel space representing a three-dimensional region. As the non-estimation target voxel group, a voxel group not included in the field of view of any one or a plurality of images obtained by imaging the three-dimensional region is identified.

The estimation/completion processing S12 is processing for calculating voxel values of estimable voxels among voxels included in the estimation target voxel group obtained by excluding the non-estimation target voxel group from the voxel space and complementing the voxel values of the non-estimable voxels. The estimable voxels refer to voxels whose voxel values can be estimated from one or a plurality of images among the voxels included in the estimation target voxel group obtained by excluding the non-estimation target voxel group from the voxel space. The voxel values of the estimable voxels are calculated with reference to one or a plurality of images. The non-estimable voxels refer to voxels whose voxel values cannot be estimated from one or a plurality of images. The voxel values of the non-estimable voxels are complemented with reference to the voxel values of the estimable voxels.

The assignment processing S13 is processing for assigning the confidence level of the voxel value of the voxel to each voxel included in the estimation target voxel group. As the confidence level assigned to each of the non-estimable voxels, a confidence level lower than the confidence level assigned to each estimable voxel is assigned.

### Effects of Processing Device 1

As described above, the processing device 1 according to the present example embodiment has a configuration in which the voxel values of the non-estimable voxels in the estimation target voxel group are complemented. In the processing device 1 according to the present example embodiment, the voxel values of the non-estimable voxels can be complemented without performing labeling corresponding to the type of subject or performing training based on synthetic data created in advance, before complementing the voxel values. Therefore, it is possible to provide a new technology for complementing a portion that is not reproduced when the three-dimensional structure is reproduced from the image obtained by imaging the three-dimensional region. In particular, in the present disclosure, it is also possible to reproduce a three-dimensional structure in which it is difficult to perform labeling corresponding to the type of subject and create synthetic data with information regarding a complete three-dimensional structure in advance. Therefore, the present disclosure can also be applied to the processing of an outdoor three-dimensional region, a three-dimensional region having many unknown subjects, and the like, to which the conventional technology has been difficult to apply.

### Specific Example of Image

The image may be a color image and/or a depth image. For example, an image in which color information (RGB value) and depth information are allocated to each pixel can be used.

### Specific Example of Specification Unit 11

The specification unit 11 can identify the non-estimation target voxel group with reference to the camera position and orientation of each camera that acquires one or a plurality of images and the field of view of the camera.

### Specific Example of Estimation/completion Unit 12

The voxel value of each voxel is a value including three-dimensional coordinates of the voxel and features of the voxel determined based on the image. The features of each voxel determined based on the image may include for example, an RGB value, and a normal vector.

An example of the non-estimable voxel includes an occluded voxel and a missing voxel. The occluded voxel is a voxel corresponding to a point that is not included as a subject in any one or a plurality of images. The missing voxel is a voxel corresponding to a point at which a depth value is not given in the image, or a point at which the depth values are inconsistent among the images even when the voxel is included as a subject in a plurality of images.

For example, the occluded voxel refers to a voxel corresponding to a point that is not acquired by any camera, such as a point that is not reproduced due to the movement and position of the camera at the time of acquiring each image, and a point that becomes a blind spot due to an object in the foreground and is not reproduced. For example, the occluded voxel may include a voxel corresponding to a point included as a subject in one color image among a plurality of color images. Since a point included in only one color image cannot be estimated for a depth value, the voxel values are not calculated as the estimable voxels, and the occluded voxels included in the estimation target voxel group can be interpolated.

The missing voxel refers to a voxel corresponding to a point at which a depth value is not given in the image, or a point at which the depth values are inconsistent among a plurality of images even when the voxel is included as a subject in the plurality of images. Such a point in the three-dimensional region is, for example, a point that is included as a subject in a plurality of two-dimensional images, but to which not texture is assigned even through edge processing or the like.

As the voxel values of the non-estimable voxels, for example, the voxel values of the estimable voxel nearest to the non-estimable voxels can be complemented.

### Specific Example of Assignment Unit 13

For example, the assignment unit 13 can assign, as the confidence level assigned to the occluded voxel, the confidence level that decreases as the distance from the occluded voxel to the estimable voxel closest to the occluded voxel increases.

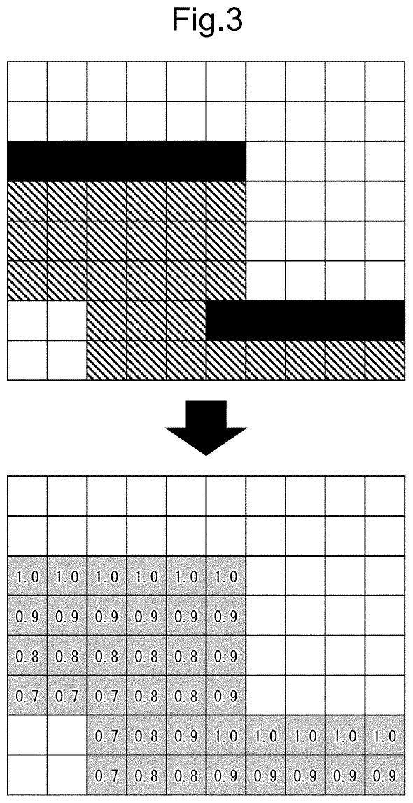

An example of assigning the confidence level to the occluded voxel will be described with reference to FIG. 3. FIG. 3 is a cross-sectional view of the estimation target voxel group generated from a plurality of two-dimensional images obtained by imaging a step as a three-dimensional region. Each cell indicates one voxel. In the upper part of FIG. 3, the voxels shown in black represent estimable voxels and the voxels shown with hatching represent occluded voxels. The voxels shown in white are voxels that do not correspond to the subject.

An example of processing of assigning the confidence level in the assignment unit 13 will be described with reference to the lower part of FIG. 3. The assignment unit 13 assigns a confidence level of 1.0 to the estimable voxels. The assignment unit 13 assigns a confidence level of 0.9 to the occluded voxels facing the estimable voxels, a confidence level of 0.8 to the occluded voxels that are one cell away, a confidence level of 0.7 to the occluded voxels that are two cells away, and does not assign a confidence level to voxels that are more than two cells away. In this manner, the assignment unit 13 assigns, to the occluded voxels, the confidence level in which the value decreases as the distance to the estimable voxels closest to the occluded voxels increases.

For example, the assignment unit 13 can assign the confidence level that decreases as a difference between a depth value set for a pixel corresponding to a missing voxel among pixels constituting an image and a depth value to be set for the pixel estimated from the position of the missing voxel in the voxel space increases, as the confidence level to be assigned to each of the missing voxels corresponding to a point at which the depth values are inconsistent among a plurality of images. The depth value of each pixel of the image can be, for example, a depth value determined based on a plurality of color images, a depth value acquired together with the image by an RGB-D camera that images a three-dimensional region, a depth value acquired by Lidar used in the same position and orientation as those of the color image, a depth value of the depth image acquired by the Lidar, or the like. The depth value to be set for the pixel estimated from the position of each missing voxel in the voxel space can be determined by a projection method.

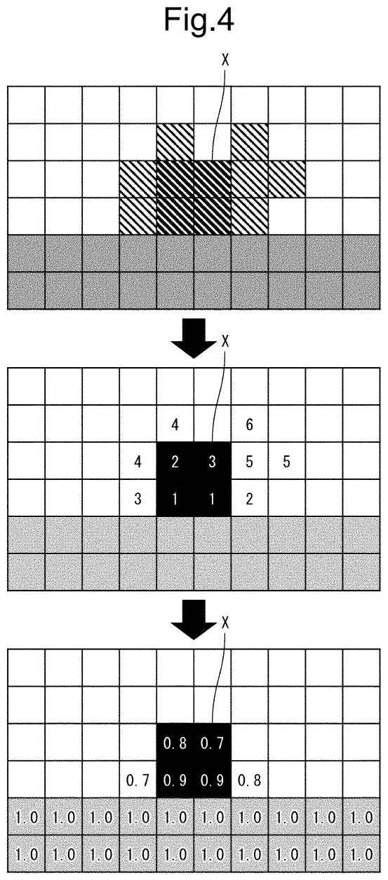

An example of assigning the confidence level to the missing voxel will be described with reference to FIG. 4. Each diagram of FIG. 4 illustrates a projection plane when an estimation target voxel group generated from a plurality of two-dimensional images captured as a three-dimensional region is projected on one two-dimensional image among the plurality of two-dimensional images. Here, the estimation target voxel includes a missing voxel.

In the upper part of FIG. 4, the voxels shown in gray represent pixels corresponding to the estimable voxels and the voxels shown with hatching represent pixels corresponding to the missing voxels. Among the missing voxels, the voxels shown by thick hatching represent voxels corresponding to a subject X. The voxels shown in white are voxels that do not correspond to the subject.

The middle part of FIG. 4 schematically illustrates, for each of the missing voxels, a result of calculating a difference between the depth value of each pixel of the projection image projected on one two-dimensional image and the depth value of the pixel in the depth image corresponding to the two-dimensional image by using numerical values of one to six. This indicates that the difference between the depth values increases as the values increase.

The lower part of FIG. 4 is a diagram illustrating a result of assigning the confidence level to each missing voxel based on the magnitude of the difference. A voxel with a difference value of one is assigned the confidence level of 0.9, a voxel with a difference value of two is assigned the confidence level of 0.8, and a voxel with a difference value of three is assigned the confidence level of 0.7. No confidence level is assigned to a voxel with a difference value of four or more.

### Modification Example of Processing Device 1

The processing device 1 described above has a configuration in which the estimation/completion unit 12 and the assignment unit 13 sequentially and independently perform processing, but is not limited thereto, and the estimation/completion unit 12 and the assignment unit 13 can perform processing in parallel as in processing by a truncated signed distance function (TSDF). For example, the estimation/completion unit 12 and the assignment unit 13 can calculate the voxel values of the estimable voxels among the voxels included in the estimation target voxel group obtained by excluding the non-estimation target voxel group from the voxel space, and in the process of complementing the voxel values of the non-estimable voxels, the confidence level of each of the voxels can be assigned with reference to scores based on the distance from the estimable voxels in the vicinity of the non-estimable voxels.

### Second Example Embodiment

A second example embodiment of the present invention will be described in detail with reference to the drawings. Components having the same functions as the components described in the first example embodiment are denoted by the same reference signs, and the description thereof will be appropriately omitted.

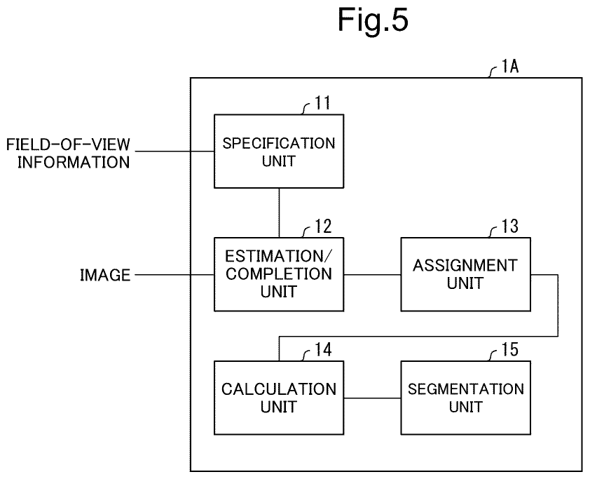

As illustrated in FIG. 5, a processing device 1A includes a specification unit 11, an estimation/completion unit 12, an assignment unit 13, a calculation unit 14, and a segmentation unit 15. The specification unit 11, the estimation/completion unit 12, the assignment unit 13, the calculation unit 14, and the segmentation unit 15 are configured to implement a specification means, an estimation/completion means, an assignment means, a calculation means, and a segmentation means, respectively, in the present example embodiment.

### Configuration of Processing Device 1A

The specification unit 11, the estimation/completion unit 12, and the assignment unit 13 of the processing device 1A are components having the same functions as those of the specification unit 11, the estimation/completion unit 12, and the assignment unit 13 of the processing device 1.

The calculation unit 14 is configured to calculate the features of each voxel included in the estimation target voxel group. The features of each voxel are calculated with reference to the voxel values of the voxels and the confidence levels assigned to the voxels.

The segmentation unit 15 is configured to execute semantic segmentation of the estimation target voxel group and determine a label of the voxel. The semantic segmentation is executed with reference to the features of each voxel included in the estimation target voxel group.

### Flow of Processing Method S1A

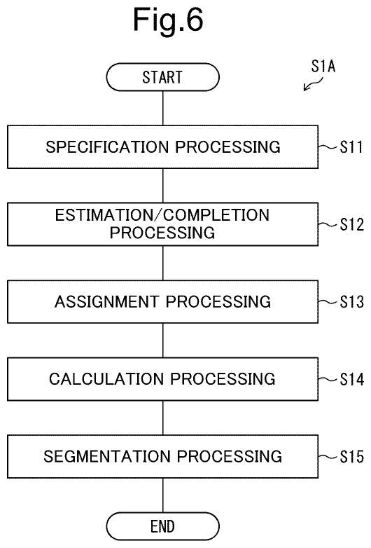

A flow of a processing method S1A according to the present example embodiment will be described with reference to FIG. 6. FIG. 6 is a flowchart illustrating the flow of the processing method S1A.

As illustrated in FIG. 6, the processing method S1A includes specification processing S11, estimation/completion processing S12, assignment processing S13, calculation processing S14, and segmentation processing S15.

The calculation processing S14 is processing for calculating the features of each voxel included in the estimation target voxel group. The features of each voxel are calculated with reference to the voxel values of the voxels and the confidence levels assigned to the voxels.

The segmentation processing S15 is processing for executing semantic segmentation of the estimation target voxel group and determining a label of the voxel. The semantic segmentation is executed with reference to the features of each voxel included in the estimation target voxel group.

### Effects of Processing Device 1A

The processing device 1A according to the present example embodiment has a configuration for executing semantic segmentation for the estimation target voxel group in which the non-estimable voxels are complemented. Therefore, in the processing device 1A according to the present example embodiment, in addition to the effect obtained by the processing device 1 according to the first example embodiment, an effect that highly accurate semantic segmentation can be performed can be obtained.

### Modification Example of Segmentation Unit 15

The processing device 1A may include a configuration that executes a task other than semantic segmentation instead of or in addition to the segmentation unit 15. For example, the processing device 1A may include a task execution unit for executing an object detection task that detects a three-dimensional region around a target object while surrounding the target object with a bounding box. For example, a task execution unit for executing a completion task may be provided.

### Third Example Embodiment

A third example embodiment of the present invention will be described in detail with reference to the drawings. Components having the same functions as the components described in the first example embodiment and the second example embodiment are denoted by the same reference signs, and the description thereof will be omitted.

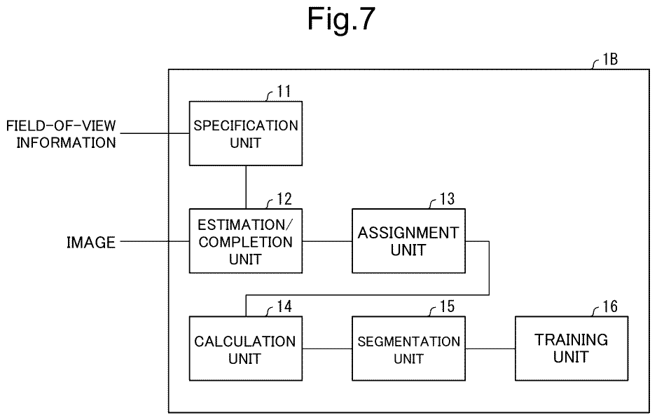

As illustrated in FIG. 7, a processing device 1B includes a specification unit 11, an estimation/completion unit 12, an assignment unit 13, a calculation unit 14, a segmentation unit 15, and a training unit 16. The specification unit 11, the estimation/completion unit 12, the assignment unit 13, the calculation unit 14, the segmentation unit 15, and the training unit 16 are configured to implement a specification means, an estimation/completion means, an assignment means, a calculation means, a segmentation means, and a training means, respectively, in the present example embodiment.

### Configuration of Processing Device 1B

The specification unit 11, the estimation/completion unit 12, the assignment unit 13, the calculation unit 14, and the segmentation unit 15 of the processing device 1B are components having the same functions as those of the specification unit 11, the estimation/completion unit 12, and the assignment unit 13 of the processing device 1, and those of the calculation unit 14 and the segmentation unit 15 of the processing device 1A.

The training unit 16 is a configuration for generating a model used by the calculation unit 14 to calculate the features using the machine learning. The training unit 16 uses, in the machine learning, training data including, as ground truth labels, estimation features estimated from the features of the estimable voxels present around the non-estimable voxels, as the features of the non-estimable voxels.

### Flow of Processing Method S1B

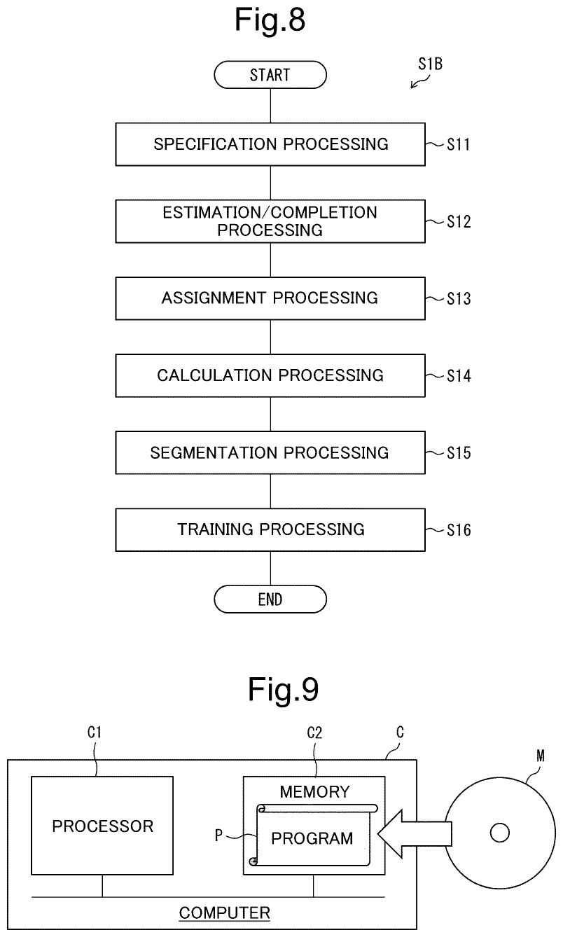

A flow of a processing method S1A according to the present example embodiment will be described with reference to FIG. 8. FIG. 8 is a flowchart illustrating the flow of the processing method S1B.

As illustrated in FIG. 8, the processing method S1B includes specification processing S11, estimation/completion processing S12, assignment processing S13, calculation processing S14, segmentation processing S15, and training processing S16.

The training processing S16 is a configuration for generating a model used to calculate the features using the machine learning. In the training processing S16, training data including, as ground truth labels, estimation features estimated from the features of the estimable voxels present around the non-estimable voxels is used in the machine learning, as the features of the non-estimable voxels.

### Effects of Processing Device 1B

As described above, the processing device 1B according to the present example embodiment has a configuration in which a model used to calculate features is generated by the machine learning. Therefore, in the processing device 1B according to the present example embodiment, an effect that a model that can perform highly accurate semantic segmentation can be obtained.

### Specific Example of Training Unit 16

The training unit 16 uses, as the training data, data to which a ground truth label is assigned, as the features of the non-estimable voxel. The training data is created from the estimation target voxel group generated by the estimation/completion unit 12. As the training data of the estimable voxels included in the estimation target voxel group, the features of the ground truth label are assigned with reference to the voxel values. The training data for the non-estimable voxels included in the estimation target voxel group can be values obtained by copying the ground truth labels for the voxels closest to the non-estimable voxels, values obtained by applying the features of each neighboring voxel to the features of the non-estimable voxels according to the distance to a plurality of neighboring voxels, or the like.

The training unit 16 can update the model used by the calculation unit 14 to calculate the features based on a first deviation that is a deviation between the generated training data and the features of each voxel calculated by the calculation unit 14. In the calculation of the first deviation, the training data and the features of each voxel, which are calculated based on each of the estimable voxels and the non-estimable voxels, are used. For example, the training unit 16 can update the model used by the calculation unit 14 to calculate the features such that the sum of the first deviations becomes minimum.

The training unit 16 can further execute training by using training data for images in which a ground truth label is assigned to each pixel included in each of one or a plurality of images used to generate the estimation target voxel group. For example, the training unit 16 can update the model used by the calculation unit 14 to calculate the features based on a second deviation that is a deviation between the training data for the two-dimensional images and the features of voxels calculated by the calculation unit 14 corresponding to the pixels. For example, the training unit 16 can calculate the sum of the second deviations and use the result for updating the model used by the calculation unit 14 to calculate the features.

Here, for each of one or a plurality of images, the position of the two-dimensional image can be determined in the estimation target voxel group by referring to the estimation result of the position and orientation of the camera when the two-dimensional image is captured. Thus, for each pixel in the two-dimensional image, a voxel in the estimation target voxel group corresponding to the pixel can be determined.

### Modification Example of Processing Device 1B

The calculation unit 14 can further calculate features of each pixel in the two-dimensional image for each of one or a plurality of images.

The segmentation unit 15 may include a configuration for executing semantic segmentation based on the features of each voxel in the estimation target voxel group and the features of each two-dimensional image.

The training unit 16 can execute training by using training data for one or a plurality of images in which a ground truth label is assigned to each pixel included in each of one or a plurality of images. The training unit 16 can update the model used by the calculation unit 14 to calculate the features based on a third deviation that is a deviation between the training data for one or a plurality of images and the features of each pixel in one or a plurality of images calculated by the calculation unit 14. For example, the training unit 16 can calculate the sum of the second deviations and use the result for updating the model used by the calculation unit 14 to calculate the features. With such a configuration, the semantic segmentation can be performed with reference to both the features of each voxel and the features of each pixel, and thus more robust semantic segmentation can be implemented.

### Modification Example of Training Unit 16

When the processing device 1B includes a task execution unit instead of the segmentation unit 15, the training unit 16 can perform training by using training data created according to a task executed by the task execution unit.

### Example of Implementation by Software

Some or all of the functions of the processing devices 1, 1A, and 1B may be achieved by hardware such as an integrated circuit (IC chip) or may be achieved by software.

In the latter case, the processing devices 1, 1A, and 1B are implemented, for example, by a computer that executes commands in a program that is software for achieving each function. FIG. 9 illustrates an example of such a computer (hereinafter, referred to as a computer C). The computer C includes at least one processor C1 and at least one memory C2. A program P for causing the computer C to operate as the processing devices 1, 1A, and 1B is recorded in the memory C2. In the computer C, the processor Cl executes each function of the processing devices 1, 1A, and 1B by reading the program P from the memory C2 and executing the program P.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from other devices. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

### Supplementary Note Item 1

The present invention is not limited to the above-described example embodiments, and various modifications can be made within the scope described in the claims. For example, example embodiments obtained by appropriately combining the technical means disclosed in the above-described example embodiments are also included in the technical scope of the present invention.

### Supplementary Note Item 2

Some or all the above-described example embodiments may be described as the follows. However, the present invention is not limited to the following aspects.

### Supplementary Note 1)

A processing device including: a specification means for identifying, as a non-estimation target voxel group, a voxel group not included in any field of view of one or a plurality of images obtained by imaging a three-dimensional region in a voxel space representing the three-dimensional region; an estimation/completion means for calculating, with reference to the one or the plurality of images, voxel values of estimable voxels whose voxel values are capable of being estimated from the one or the plurality of images, among voxels included in estimation target voxel group obtained by excluding the non-estimation target voxel group from the voxel space, and complementing voxel values of non-estimable voxels whose voxel values are not capable of being estimated from the one or the plurality of images with reference to the voxel values of the estimable voxels; and an assignment means for assigning, to each voxel included in the estimation target voxel group, a confidence level of a voxel value of the voxel, in which the assignment means assigns a confidence level lower than the confidence level assigned to each of the estimable voxels as the confidence level assigned to each of the non-estimable voxels.

In this configuration, it is possible to provide a new technology for complementing a portion that is not reproduced when a three-dimensional structure is reproduced from the image obtained by imaging the three-dimensional region.

### Supplementary Note 2

The processing device according to Supplementary note 1, in which the non-estimable voxel includes an occluded voxel corresponding to a point that is not included as a subject in any of the one or the plurality of images, and a missing voxel corresponding to a point that is not given a depth value in any of the one or the plurality of images, or a point that is included as the subject in the plurality of images but has depth values that are inconsistent among the images.

In this configuration, the non-estimable voxel can be identified in more detail based on the occurrence factor.

### Supplementary Note 3

The processing device according to Supplementary note 2, in which the assignment means assigns, as the confidence level assigned to each occluded voxel, the confidence level that decreases as a distance from the occluded voxel to the estimable voxel closest to the occluded voxel increases.

In this configuration, a pseudo label can be assigned to the occluded voxel.

### Supplementary Note 4

The processing device according to Supplementary note 2 or 3, in which the assignment means assigns the confidence level that decreases as a difference between a depth value set for a pixel corresponding to the missing voxel among pixels constituting the image and a depth value to be set for the pixel estimated from a position of the missing voxel in the voxel space increases, as the confidence level to be assigned to each of the missing voxels corresponding to a point at which the depth values are inconsistent among the images.

In this configuration, a pseudo label can be assigned to the missing voxel.

### (supplementary Note 5

The processing device according to any one of Supplementary notes 1 to 4, further including:
a calculation means for calculating features of each voxel included in the estimation target voxel group with reference to the voxel value of each voxel and the confidence level assigned to each voxel; and
a segmentation means for executing semantic segmentation of the estimation target voxel group with reference to the features of each voxel included in the estimation target voxel group, and determining a label of each voxel.

In this configuration, highly accurate semantic segmentation can be performed.

### Supplementary Note 6

The processing device according to Supplementary note 4, further including a training means for generating, through machine learning, a model used by the calculation means to calculate the features, in which the training means uses, for the machine learning, training data including, as ground truth labels, estimation features estimated from features of the estimable voxels present around the non-estimable voxels, as features of the non-estimable voxels.

In this configuration, a model that can perform highly accurate semantic segmentation can be obtained.

### Supplementary Note 7

A processing method including causing at least one processor to: identify, as a non-estimation target voxel group, a voxel group not included in any field of view of one or a plurality of images obtained by imaging a three-dimensional region in a voxel space representing the three-dimensional region; calculate, with reference to the one or the plurality of images, voxel values of estimable voxels whose voxel values are capable of being estimated from the one or the plurality of images, among voxels included in estimation target voxel group obtained by excluding the non-estimation target voxel group from the voxel space, and complement voxel values of non-estimable voxels whose voxel values are not capable of being estimated from the one or the plurality of images with reference to the voxel values of the estimable voxels; and assign, to each voxel included in the estimation target voxel group, a confidence level indicating a confidence level of a voxel value of the voxel, and assign a confidence level lower than the confidence level assigned to each of the estimable voxels as the confidence level assigned to each of the non-estimable voxels.

In this configuration, it is possible to provide a new technology for complementing a portion that is not reproduced when a three-dimensional structure is reproduced from the image obtained by imaging the three-dimensional region.

### Supplementary Note 8

A program for causing a computer to function as a processing device, the program for causing at least one processor included in the computer to function as: a specification means for identifying, as a non-estimation target voxel group, a voxel group not included in any field of view of one or a plurality of images obtained by imaging a three-dimensional region in a voxel space representing the three-dimensional region; an estimation/completion means for calculating, with reference to the one or the plurality of images, voxel values of estimable voxels whose voxel values are capable of being estimated from the one or the plurality of images, among voxels included in estimation target voxel group obtained by excluding the non-estimation target voxel group from the voxel space, and complementing voxel values of non-estimable voxels whose voxel values are not capable of being estimated from the one or the plurality of images with reference to the voxel values of the estimable voxels; and an assignment means for assigning, to each voxel included in the estimation target voxel group, a confidence level of a voxel value of the voxel, in which the assignment means assigns a confidence level lower than the confidence level assigned to each of the estimable voxels as the confidence level assigned to each of the non-estimable voxels.

In this configuration, it is possible to provide a new technology for complementing a portion that is not reproduced when a three-dimensional structure is reproduced from the image obtained by imaging the three-dimensional region.

### Supplementary Note Item 3

Some or all the above-described example embodiments may be described as the follows.

A processing device including at least one processor, in which the processor executes specification processing of identifying, as a non-estimation target voxel group, a voxel group not included in any field of view of one or a plurality of images obtained by imaging a three-dimensional region in a voxel space representing the three-dimensional region, estimation/completion processing of calculating, with reference to the one or the plurality of images, voxel values of estimable voxels whose voxel values are capable of being estimated from the one or the plurality of images, among voxels included in estimation target voxel group obtained by excluding the non-estimation target voxel group from the voxel space, and complementing voxel values of non-estimable voxels whose voxel values are not capable of being estimated from the one or the plurality of images with reference to the voxel values of the estimable voxels, and an assignment means for assigning, to each voxel included in the estimation target voxel group, a confidence level of a voxel value of the voxel, in which the assignment means assigns a confidence level lower than the confidence level assigned to each of the estimable voxels as the confidence level assigned to each of the non-estimable voxels.

The processing device may further include a memory, and the memory may store a program for causing the processor to execute the specification processing, the estimation/completion processing, and the assignment processing. This program may be recorded in a computer-readable non-transitory tangible recording medium.

### Reference Signs List

1, 1A, 1B processing device
11 specification unit
12 estimation/completion unit
13 assignment unit
14 calculation unit
15 segmentation unit
16 training unit

What is claimed is:

1. A processing device comprising:
at least one memory storing instructions; and
at least one processor configured to execute the instructions to:
identify, as a non-estimation target voxel group, a voxel group not included in any field of view of one or a plurality of images obtained by imaging a three-dimensional region in a voxel space representing the three-dimensional region;
calculate, with reference to the one or the plurality of images, voxel values of estimable voxels whose voxel values are capable of being estimated from the one or the plurality of images, among voxels included in estimation target voxel group obtained by excluding the non-estimation target voxel group from the voxel space, and complement voxel values of non-estimable voxels whose voxel values are not capable of being estimated from the one or the plurality of images with reference to the voxel values of the estimable voxels; and
assign, to each voxel included in the estimation target voxel group, a confidence level of a voxel value of the voxel, wherein a confidence level assigned to each of the non-estimable voxels is lower than the confidence level assigned to each of the estimable voxels.

2. The processing device according to claim 1,
wherein the non-estimable voxel includes an occluded voxel corresponding to a point that is not included as a subject in any of the one or the plurality of images, and a missing voxel corresponding to a point that is not given a depth value in any of the one or the plurality of images, or a point that is included as the subject in the plurality of images but has depth values that are inconsistent among the plurality of images.

3. The processing device according to claim 2,
wherein the at least one processor is further configured to execute the instructions to:
assign, the confidence level assigned to each occluded voxel, the confidence level that decreases as a distance from the occluded voxel to the estimable voxel closest to the occluded voxel increases.

4. The processing device according to claim 2,
wherein the at least one processor is further configured to execute the instructions to:
assign confidence level that decreases as a difference between a depth value set for a pixel corresponding to the missing voxel among pixels constituting the image and a depth value to be set for the pixel estimated from a position of the missing voxel in the voxel space increases, as the confidence level to be assigned to each of the missing voxels corresponding to a point at which the depth values are inconsistent among the plurality of images.

5. The processing device according to claim 1,
wherein the at least one processor is further configured to execute the instructions to:
calculate features of each voxel included in the estimation target voxel group with reference to the voxel value of each voxel and the confidence level assigned to each voxel; and
execute semantic segmentation of the estimation target voxel group with reference to the features of each voxel included in the estimation target voxel group, and determining a label of each voxel.

6. The processing device according to claim 5,
wherein the at least one processor is further configured to execute the instructions to:
train, through machine learning, a model, using training data including, as ground truth labels, estimation features estimated from features of the estimable voxels present around the non-estimable voxels, as features of the non-estimable voxels.

7. A processing method comprising:
by at least one processor,
identifying as a non-estimation target voxel group, a voxel group not included in any field of view of one or a plurality of images obtained by imaging a three-dimensional region in a voxel space representing the three-dimensional region;
calculating, with reference to the one or the plurality of images, voxel values of estimable voxels whose voxel values are capable of being estimated from the one or the plurality of images, among voxels included in estimation target voxel group obtained by excluding the non-estimation target voxel group from the voxel space, and complementing voxel values of non-estimable voxels whose voxel values are not capable of being estimated from the one or the plurality of images with reference to the voxel values of the estimable voxels; and
assigning a confidence level lower than the confidence level assigned to each of the estimable voxels as the confidence level assigned to each of the non-estimable voxels.

8. A non-transitory recording medium recording a program for causing a computer to execute:
identifying, as a non-estimation target voxel group, a voxel group not included in any field of view of one or a plurality of images obtained by imaging a three-dimensional region in a voxel space representing the three-dimensional region;
calculating, with reference to the one or the plurality of images, voxel values of estimable voxels whose voxel values are capable of being estimated from the one or the plurality of images, among voxels included in estimation target voxel group obtained by excluding the non-estimation target voxel group from the voxel space, and complementing voxel values of non-estimable voxels whose voxel values are not capable of being estimated from the one or the plurality of images with reference to the voxel values of the estimable voxels; and
assigning a confidence level lower than the confidence level assigned to each of the estimable voxels as the confidence level assigned to each of the non-estimable voxels.
